(19) United States
(12) Patent Application Publication
(10) Pub. No.: US 2008/0305357 A1
(43) Pub. Date: Dec. 11, 2008

(54) COLOR MATCHING PROCESS FOR MAXIMIZING HIDING AND WORKABILITY WITH WATERBORNE COATING COMPOSITIONS

(75) Inventors: Calum H. Munro, Wexford, PA (US); Leigh-Ann Humbert, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/758,765

(22) Filed: Jun. 6, 2007

(51) Int. Cl. C23F 3/00; G01N 31/00

(52) U.S. Cl. 428/687; 702/30

(57) ABSTRACT

A method of selecting tints for a colored coating composition is disclosed. The method includes (a) providing a plurality of tints, each tint comprising a pigment dispersed in a resinous carrier binder; (b) preparing a plurality coating composition, each coating compositions comprising a resinous coating binder and at least one of the tints, the total binder content being the amount of carrier binder and coating binder; (c) determining the absorbance of radiation in a wavelength band of each coating composition; (d) identifying coating compositions of step (b) having a maximum weight ratio of pigment to total binder and a maximum amount of resinous carrier binder and exhibiting a minimum absorbance in the wavelength band; and (e) selecting the tints from the coating compositions identified in step (d) for use in preparing a colored coating composition.

### FIELD OF THE INVENTION

The present invention is directed to a method of selecting tints for achieving a target color of a basecoat composition in a primeness painting system.

### BACKGROUND OF THE INVENTION

As used herein, a pigmented coating composition is considered to provide hiding of an underlying layer when the coating composition absorbs radiation, at least in the visible spectrum. Pigments are generally selected for inclusion in a basecoat coating composition to achieve a desired color and to provide maximum hiding by the basecoat composition of an underlying substrate or coating layer.

Traditional coating systems, particularly for automotive applications, involve a multi-coating process. The substrate is typically metallic and is electrocoated with an organic resin. The resinous electrocoated layer is baked and allowed to cool. A primer composition is sprayed onto the electrocoated layer. After baking the primer layer to drive off the solvent (which may be water), the primer layer is sanded to prepare the surface for application of a basecoat composition. The basecoat composition is coated over the primer layer and is baked to remove solvent and then sanded for application of a clearcoat composition thereover. Typically, the primer layer is about 25 mm thick. The basecoat layer is about 12-20 mm thick, and the clearcoat layer is about 40 mm thick.

A primer layer has been employed for one or more purposes. The primer layer can minimize the impact of chipping that may otherwise expose the metallic substrate. Upon failure of the outer layers of a clearcoat and basecoat, such as occurs from road debris striking an automobile (referred to as chipping), the primer layer protects the underlying metal from exposure to the environment and minimizes corrosion of the underlying metal. The primer layer can also smooth out surface roughness of the metal substrate. A smooth metal surface is desirable in many applications and, while the metal substrate itself may be polished to be smooth, such a polishing process is costly. Instead, the primer layer can fill in rough features on the metal surface and evens out the metal surface. Finally, the primer layer can provide hiding of the electrocoat layer to minimize or prevent photo-oxidation of the electrocoat layer. Of particular concern is the transmission of wavelengths of visible light in the blue wavelength range that can photo-oxidize the aromatic moieties of an electrocoated resin. The primer layer generally is designed to prevent or minimize transmission of visible light at wavelengths in the blue wavelength range. While primer layers successfully achieve one or more of these purposes, there are significant costs associated with the materials for applying the primer, the energy for baking the primer layer and labor costs associated with spraying, baking and sanding the primer. In addition, spraying of any coating composition can be detrimental to the environment and extra controls are required to prevent over-spraying of the primer composition.

More recently, systems of applying coating compositions to automotive components have been directed to avoiding the use of a primer layer, i.e., primerless coating systems. In these systems, one or more basecoat layers are applied directly to the electrocoat layer. A clearcoat is then applied over the basecoat layers. In order to achieve hiding, the basecoat layer(s) of the primeness system typically are thicker than in conventional automotive coating systems and is opaque from the use of colorants in order to achieve high hiding. The basecoat composition includes a resinous binder and colorants and is applied to an electrocoated substrate at a relatively low solid level (e.g., 18% solids) and, thus, is considered to be wet. Wet coating compositions are difficult to apply in thick layers (e.g., 25 mm thick), because they tend to sag and form surface defects before they can harden and dry. Also, surface defects can occur in the form of pinholes when air is entrapped during application of high amounts of coating composition sprayed onto the electrocoated layer. One solution for applying a thick layer of basecoat is to apply two separate layers of the basecoat composition. Most existing automotive paint shops are arranged to apply coating compositions in multiple steps. This process of applying one basecoat layer and a second basecoat layer in a “wet-on-wet” process creates a composite, thick basecoat layer, which otherwise would not be able to be sprayed directly onto the electrocoat layer.

The desired color for a coating system is achieved by including pigments in the basecoat layers. Typically, the first layer that is applied directly to the electrocoat layer has a color that is close to the desired color of the final coating system. This first layer is relatively thick (about 15 mm) and generally does not include color effect pigments (flake pigments) that might be free to flow through the thickness of the layer and create roughness in the surface of the layer. As such, the underlying basecoat layer is sufficiently thick and contains an amount of pigment to provide color, but not so thick as to cause surface defects. The second basecoat layer delivers the desired color for the coating system and may include color effect pigments.

In order to achieve the desired color for the coating system, conventional color matching processes are employed to identify a set of pigments that together provide the desired color and color effect for the coating system. The desired color of the coating system is a function of the absorbance spectrum for the set of pigments used therein. Oftentimes, however, a concentration of pigment (referred to as the pigment loading level) that achieves a desired color still exhibits minimal absorption at wavelengths less than 600 nm. In order to prevent degradation of an underlying electrocoated layer, the absorption of light, particularly in the 300-500 nm range, may be increased by increasing the pigment loading level. However, high pigment loading creates a high ratio of the amount of pigment to the amount of resinous binder (termed the pigment-to-binder ratio) in the basecoat composition. When a basecoat composition having a high pigment-to-binder ratio is coated onto a substrate, coating defects are often experienced, including low chip resistance, low adhesion to an electrocoated layer, pinholing and roughness.

Accordingly, a need remains for a basecoat composition for applying directly to an electrocoat layer in a primeness coating system, wherein the pigment loading of the basecoat layer is relatively low to achieve acceptable coating properties, yet provides a high degree of hiding of the underlying electrocoat layer.

### SUMMARY OF THE INVENTION

This need is met by the method of the present invention of selecting tints for use in preparing a colored coating composition comprising: (a) providing a plurality of tints, each tint comprising a colorant dispersed in a resinous carrier binder; (b) preparing a plurality of coating compositions, each coating composition comprising a resinous coating binder and at least one of the tints, the total binder content being the amount of carrier binder and coating binder; (c) determining the absorbance of radiation in a wavelength band of each coating composition; and (d) identifying coating compositions of step (b) having a predetermined maximum weight ratio of pigment to total binder and a predetermined maximum amount of resinous carrier binder and having a predetermined minimum absorbance in the wavelength band. The present invention also includes a primeness coating system comprising a resinous electrocoated layer and a basecoat layer applied directly thereto, the basecoat layer comprising a colored coating composition comprising a basecoat binder and a plurality of tints comprising a colorant and a carrier binder, wherein the tints in combination exhibit a minimum absorbance in a wavelength band, wherein the amount of carrier binder in the composition is less than 20 wt. % of the total amount of the basecoat binder and the carrier binder. Another aspect of the present invention is a coated substrate comprising a metal substrate covered by an electrodeposited coating layer; a coating system applied to the electrodeposited layer without a primer layer therebetween, the coating system comprising a hiding layer and a color layer; wherein the hiding layer comprises a binder and a plurality of tints comprising a colorant and a carrier binder, wherein the tints in combination exhibit a target absorbance spectrum, each of the tints exhibiting at least a predetermined minimum absorbance at 300-700 nm.

### DETAILED DESCRIPTION OF THE INVENTION

The present invention includes a method of selecting tints for a colored coating composition. In certain embodiments, these coating compositions may be used as a basecoat composition in a primeness coating system. The method of the present invention includes identifying a target color and selecting tints to achieve that color with high hiding in a predetermined wavelength band from a subset of tints that, when included in a primeness coating system, result in acceptable coating properties, including adhesion to substrates (particularly metallic substrates), minimal pinholing, suitable roughness and/or high chip resistance. A tint is referred to herein as a colorant composition containing a colorant and carrier binder.

The target color for a basecoat composition of a primeness coating system is identified from a color sample, such as a previously produced coating system or a color from a colored article, a color swatch or the like. The coating produced according to the present invention achieves the target color by having an absorption spectrum in the visible spectrum that substantially matches the visible absorption spectrum of the target color. By substantially matches, it is meant that the color of a coating system produced using the present invention is indistinguishable from the target color at least to the human eye. The present invention identifies a set of tints that have suitable coating properties. Certain of those tints are combined to reproduce the absorption spectrum of the target color.

The absorbance spectrum of a target color over a range of wavelengths is determined. The wavelength range may be in the visible or invisible spectra of radiation. For automotive applications, the absorbance spectrum of a target color generally is determined in the visible range of 400-700 nm. The target absorbance spectrum can be determined by testing a color swatch with a spectrophotometer. Alternatively, the target absorbance spectrum can be determined by performing a conventional color match to identify a set of pigments that match the target color without concern for their coating properties (e.g., hiding or pinholing) and obtaining the absorbance spectrum from the color-matched set of pigments. Conventional color matching techniques identify tints that in combination achieve the target color. However, that set of tints typically does not provide sufficient hiding to an underlying electrocoat layer. The present invention overcomes this deficiency.

In the present invention, the tints are categorized according to their color, hiding ability and/or effect on coating properties such as pinholing. A population of conventional tints that are used for providing a color to colored coating compositions (without regard to their hiding and coating properties) are categorized according to their color, hiding ability at a particular pigment-to-binder ratio and effect on coating properties such as the tendency to cause pinholing. From the population of tints that could potentially be used to create a colored coating composition, tints are identified that provide high hiding, with minimal coating defects, including pinholing. From this set of categorized tints, a subset of tints is selected that, when added to the coating composition, yield an absorbance spectrum that substantially matches the predetermined target absorbance spectrum. The selected tints are used in a coating composition according to the present invention.

In one embodiment of the invention, an absorbance spectrum is produced for each tint of the set of categorized tints. The individual absorbance spectra for each tint are selected in a combination that reproduces the target absorbance spectrum. The subset of tints that together exhibit the target absorbance spectrum, when included in a coating composition, achieves the target color of a coating composition. This process of selecting tints with absorbance spectra that are combinable to exhibit the target absorbance spectrum may be conducted via color matching software that compares the target absorbance spectrum with the spectra of the set of categorized tints and identifies a plurality of spectra that together reproduce the absorbance curve of the target absorbance spectrum, such as by curve fitting the identified spectra to reproduce the target spectrum. The various spectra may or may not overlap in certain wavelength ranges and may have absorption peaks that vary from narrow to broad. Each of the identified spectra corresponds to a tint from the set of categorized tints. Therefore, by identifying a plurality of spectra that together result in the target absorbance spectrum, a plurality of tints are identified that when used in combination in a coating composition will absorb radiation according to the target absorbance spectrum to impart the target color to the coating composition. The intensity of color can be varied by altering the total amount of the tints used in the coating composition, while keeping the relative amounts of the tints constant. In this manner, the method of the present invention achieves excellent color matching with substrate hiding at low pigment-to-binder ratios and thus minimizes coating defects as compared to previous color matching methods. Suitable low pigment-to-binder ratios that prevent coating defects are a maximum of 0.50 or a maximum of 0.35. By selecting tints from a subset of tints that provide substrate hiding with minimal coating defects, the present invention selects tints that in combination are suitable for use in a primeness coating system.

It has been found that a subset of tints selected according to the present invention (from the set of categorized tints having desired hiding and minimal coating defects) may be distinct from tints that would otherwise have been selected according to conventional color matching techniques. In addition, the quantity of distinct tints required to achieve the target absorbance spectrum from the set of categorized tints that meet the required degree of hiding and minimal coating defect properties may be greater than the quantity of distinct tints used in conventional color matching. Similarly, the tints selected according to the present invention may have absorbance spectra that would ordinarily not be considered suitable for producing the target absorbance spectrum. For example, green tints may be selected to produce a target absorbance spectrum that appears blue, but in combination with the total subset of tints selected by the present invention, such green tints are appropriate. As a result, the individual absorbance spectra of the subset of tints identified in the present invention may constitute a unique fingerprint of colorants for a coating composition since these absorbance spectra would not ordinarily be considered useful in conventional color matching. However, the subset of tints that are selected from the set of categorized tints can be used to achieve the target absorbance spectrum in a coating composition and provide an absorbance that provides hiding to layers underlying the coating composition.

In one embodiment of the present invention, tints are selected for use in preparing a colored coating composition by providing a plurality of tints, each tint comprising a colorant dispersed in a resinous carrier binder. As used herein, the term “colorant” means any substance that imparts color and/or other opacity and/or other visual effect to the composition. The colorant can be added to the coating composition in any suitable form, such as discrete particles, dispersions, solutions and/or flakes. A single colorant or a mixture of two or more colorants can be used in the coating compositions of the present invention.

Example colorants include pigments and dyes, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

A plurality of coating compositions are prepared, with each coating composition comprising a resinous coating binder and at least one of the tints. The total relative amount of binder in each coating composition is determined from the amount of carrier binder and the amount of coating binder. The carrier binder and the coating binder may be the same or different. As used herein, the resinous binders may include polymer compositions. Suitable polymer compositions used in coatings include polyurethanes, acrylic polymers, alkyd polymers, polyesters, siloxane-containing polymers, polysulfides, epoxy-containing polymers and polymers derived from epoxy-containing polymers and combinations thereof. These are known to be provided in coatings as lacquers, thermoplastics or thermosetting types of compositions. Thermosetting compositions will further include cross-linking agents, such as polyisocyanates, amino-formaldehyde aminoplasts, polyacids, polyanhydrides and combinations thereof.

The absorbance of radiation in a wavelength band is determined for each coating composition. The coating compositions are screened for those having a predetermined minimum absorbance in the wavelength band, i.e., to provide hiding of an underlying material in the wavelength band. The coating compositions are also screened for those having a predetermined maximum weight ratio of colorant to total binder and a predetermined maximum amount of carrier binder, i.e., to have minimal tendency to form coating defects. The coating compositions meeting these screening characteristics may be characterized as being suitable for use in preparing a colored coating composition.

The set of categorized tints that achieve a desired degree of hiding and minimal tendency to form coating defects may also be categorized according to other features, such as cost. In this manner, tints can be selected based on their color, degree of hiding, minimal tendency to form coating defects and minimal cost.

In one embodiment of the invention, the tints are selected to achieve a predetermined minimal absorbance at wavelengths of 300-700 nm, such as 300-470 nm.

In another embodiment of the invention, tints are categorized by their degree of hiding and minimal tendency to form coating defects at a plurality of tint-to-binder ratios and in a plurality of pigment carriers (grind vehicles). By testing the tints at various loading ratios and in various carriers, a further refined set of categorized tints for selection to achieve the desired coating composition absorbance spectrum is produced. In prior color matched coating compositions for hiding, the amount of carrier is typically over 25% of the total solids, or over 35% of the total solids. These high levels of carrier result in higher tendency to form coating defects. As a result of selecting tints with a minimum absorbance for a maximum amount of carrier, the amount of carrier is significantly reduced to less than 25% or less than 20% of the total solids.

The present invention also includes a coating composition produced according to the method of the present invention. The colored coating composition of the present invention is characterized by a plurality of tints that, in combination, exhibit a desired absorbance spectrum and exhibit a minimum absorbance with minimal tendency to form defects in the coating composition at relatively low pigment-to-binder ratios. In one embodiment, the coating composition may be used in a primeness coating system as the first layer in a two-layer basecoat composition applied directly to an electrocoated layer on a substrate. The upper basecoat layer is a colored coating composition and may further include additional pigments and/or special effect compositions. Alternatively, the colored coating composition may be the upper basecoat layer of a two-basecoat system applied directly to an electrocoated layer on a substrate. A clearcoat layer may be applied to the two-coat colored coating composition.

Example special effect compositions that may be used in the colored coating composition of the present invention include pigments and/or compositions that produce one or more appearance effects such as reflectance, pearlescence, metallic sheen, phosphorescence, fluorescence, photochromism photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the colored coating composition of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa.

Also, as used herein, the term “polymer” is meant to refer to prepolymers, oligomers and both homopolymers and copolymers; the prefix “poly” refers to two or more.

The following examples are illustrative of the present invention and are not intended to be limiting examples.

### EXAMPLES

### Examples 1-4

### Light Green-Blue Colored Basecoat Compositions

### Example 1

### Conventional Colorant Blend

A conventional colorant blend was prepared as described below from the components listed in Table 1. This colorant blend was determined by using conventional color matching techniques to match a color standard.

TABLE 1
Conventional colorant blend

| | PARTS BY WEIGHT |
|---|---|
| COMPONENT | (grams) |
| Carbon black tint paste¹ | 0.62 |
| Titanium dioxide tint paste² | 0.10 |
| Pigment blue 60 tint paste³ | 6.16 |
| Pigment red 122 tint paste⁴ | 8.00 |
| Pigment blue 15:1 tint paste⁵ | 114.29 |

¹Tint paste comprising 6.5 grams pigment black 7 (Color Index number 77266) dispersed in a mixture comprising 33.0 grams waterborne acrylic polymer, 16.4 grams latex, 36.5 grams deionized water, 4.7 grams ethylene glycol monohexyl ether, 0.6 grams dimethylethanolamine, and 1.8 g mineral spirits. The final pigment to binder ratio of the mixture was 0.41.
²Tint paste comprising 50.0 grams titanium dioxide pigment dispersed in a mixture comprising 16.1 grams waterborne acrylic polymer, 10.1 grams latex, 12.7 grams deionized water, 2.0 grams ethylene glycol monohexyl ether, 0.1 grams dimethylethanolamine, 1.8 g mineral spirits, 2.8 grams polypropylene glycol, 2.2 grams diethylene glycol monobutyl ether and 2.1 g propylene glycol monomethyl ether. The final pigment to binder ratio of the mixture was 5.84.
³Tint paste comprising 12.5 grams pigment blue 60 (Color Index number 69800) dispersed in a mixture comprising 26.7 grams waterborne acrylic polymer, 12.5 grams latex, 41.3 grams deionized water, 3.2 grams ethylene glycol monchexyl ether, 0.3 grams dimethylethanolamine, 0.3 grams Byk 011 from Byk-Chemie and 3.1 g mineral spirits. The final pigment to binder ratio of the mixture was 1.01.
⁴Tint paste comprising 12.0 grams pigment red 122 (Color Index number 73915) dispersed in a mixture comprising 26.1 grams waterborne acrylic polymer, 12.4 grams latex, 43.2 grams deionized water, 3.7 grams ethylene glycol monohexyl ether, 0.3 grams dimethylethanolamine, and 2.1 g mineral spirits. The final pigment to binder ratio of the mixture was 0.99.
⁵Tint paste comprising 10.5 grams pigment blue 15:1 (Color Index number 74160) dispersed in a mixture comprising 30.27 grams waterborne acrylic polymer, 15.0 grams latex, 37.3 grams deionized water, 3.8 grams ethylene glycol monohexyl ether, 0.4 grams dimethylethanolamine, and 3.1 g mineral spirits. The final pigment to binder ratio of the mixture was 0.73.

### Example 2

### Aqueous Coating Composition with Conventional Colorant Blend

An aqueous basecoat composition containing the colorant blend of Example 1 was prepared as follows. An unpigmented aqueous pre-mixture (Premix A), was first prepared from the components listed in Table 2A, admixed under agitation.

TABLE 2A
Premix A

| | PARTS BY WEIGHT |
|---|---|
| COMPONENT | (grams) |
| Deionized water | 55.3 |
| Dimethylethanolamine | 0.6 |
| Palyester solution⁶ | 36.0 |
| Polyurethane dispersion⁷ | 46.0 |
| Latex emulsion⁸ | 67.1 |
| Mineral spirits⁹ | 12.8 |
| Octanol | 14.2 |

⁶Prepared as follows: In a four-neck round bottom flask equipped with a thermometer, mechanical stirrer, condenser, dry nitrogen sparge and a heating mantle, EMPOL 1008 dimerdiacid available from Cognis (4206.3 g); cyclohexyldimethanol (1100.5 g); and dimethanolpropionic acid (301.5 g); trimellitic anhydride (150.0 g were heated to a temperature of 180° C. and stirred in the flask until 257 grams of distillate was collected and the acid value dropped to the range of 22–25. The material was then cooled to a temperature of 130° C. and 2241.7 g butyl ether of propylene glycol were added. The final product was a liquid having Gardner-Holdt viscosity of Z5–Z6, a non-volatile content of 71.1% (as measured at 110° C. for one hour), and weight averaged molecular weight of 23,125 as measured by gel permeation chromatography using polystyrene standards.
⁷Prepared as follows: A polyurethane prepolymer was first prepared. A latex containing a hydrophilic polyurethane prepolymer was prepared by adding 783.2 g of N-methyl pyrrolidine, 585.6 g of hydroxyethyl methacrylate, 603.6 g of dimethylol proprionic acid, 5.9 g of butylated hydroxytoluene, 5.9 g of triphenyl phosphite, and 5.9 g of dibutyl tin dilaurate to a four necked round bottom flask fitted with a thermocouple, mechanical stirrer, and condenser and heated to 100° C. in to to 100° C. inobtain a homogeneous solution. Then 3,000.0 g of poly(butylene oxide) molecular weight 1,000 was heated to 70° C. and added. To this mixture at 90° C., isophorone diisocyanate 1,667.3 g was added over 90 minutes. The isocyanate container was rinsed with 153.0 g of butyl acrylate. The reaction mixture was stirred at 90° C. for two hours. Then, 2,979 g of butyl acrylate was added and the mixture cooled to ambient temperature. The final product had a non-volatile content of 59.1% (measured at 110° C. for one hour), a Gardner-Holdt viscosity (ASTM D1545-89) of W- and an acid value of 25.6 as measured by potentiometric titration with KOH. This polyurethane prepolymer was used in the preparation of an aqueous polyurethane dispersion using the components of Table 2B and as described below.
⁸This latex emulsion was prepared according to U.S. Pat. No. 6,762,240, Example 1, except that the methyl methacrylate and butyl acrylate were replaced with butyl methacrylate, and ethyleneglycol dimethacrylate was replaced with hexanediol diacrylate on weight basis.
⁹Shellsol odorless mineral spirits available from Shell Chemical Company.

TABLE 2B

| | |
|---|---|
| | PARTS BY |
| COMPONENTS | WEIGHT (grams) |

CHARGE 1

| | |
|---|---|
| Distilled water | 13,320.0 |
| Igepal CO-897¹⁰ | 171.4 |
| Diisopropanolamine | 360.0 |
| Polyurethane prepolymer | 8,000.0 |
| Ethyleneglycol dimethacrylate | 360.0 |
| Methyl methacrylate | 2,280.0 |
| Butylacrylate | 2,000.0 |

FEED 1

| | |
|---|---|
| Distilled water | 480.0 |
| t-Butylhydroperoxide | 12.0 |

FEED 2

| | |
|---|---|
| Distilled water | 480.0 |
| Ferrous ammonium sulfate | 0.24 |
| Sodium metabisulfite | 12.0 |

FEED 3

| | |
|---|---|
| Distilled water | 48.0 |
| Prosel GXL¹¹ | 24.0 |

Charge 1 was mixed in a stainless steel beaker until homogeneous and the mixture was microfluidized, by passing once through a Microfluidizer ® M110T at 8000 psi into a stainless steel beaker and rinsed with 600 g of water. The microfluidized mixture was transferred to a stainless steel reactor fitted with a thermometer, mechanical stirrer, and condenser, sparged with nitrogen gas. Feed 1 was added to the reactor and stirred for one minute. Then, Feed 2 was added to the reactor over 30 minutes, an exothermic reaction was observed. The polymer was cooled to 30° C. and Feed 3 was added. The final pH of the latex was 6.6, the nonvolatile content was 43.2%, (measured at 110° C. for one hour), the Brookfield viscosity was 86 cps (spindle #1, 50 rpm, 25° C.), and the particle size was 96 nanometers.
¹⁰Nonionic surfactant available from Rhodia; 70% in water.
¹¹Biocide containing 9.3% 1,2-benzisothiazolin-3-one as active ingredient, available from Syngenta Corporation, Wilmington, DE.

An aqueous basecoat composition was prepared by mixing the components listed in Table 3 under agitation. The pH of was adjusted to 8.4-8.6 using an appropriate amount of a 50% aqueous solution of dimethylethanolamine. The viscosity of the aqueous basecoat composition was reduced to 33 to 37 seconds spray viscosity (DIN #4 cup) using deionized water.

TABLE 3
Aqueous basecoat composition with conventional colorant blend

| | PARTS BY WEIGHT |
|---|---|
| COMPONENT | (grams) |
| Premix A | 232.6 |
| Colorant blend of Ex. 1 | 129.2 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327¹² | 23.3 |
| Polypropylene glycol¹³ | 5.0 |

¹²Imino functional methylated melamine formaldehyde resin available from Cytec Industries, Inc.
¹³synalox 100-D45 available from Dow Chemical Company.

An extinction spectrum was generated mathematically for the aqueous coating composition of Example 2 with assumptions that extinction varies consistently with concentration, and that component extinctions are additive in the blend. The mathematically generated extinction was taken to be the sum of the component parts. This generated extinction spectrum was adjusted by a scaling factor until the minimum extinction was sufficient to provide adequate hiding of optical wavelengths (at 300 to 700 nm). The scaling factor for the colorant blend of Example 1 was 4.85. In other words, if 4.85 times more of each tint was utilized, the hiding would be sufficient.

### Example 3

### High Hiding Colorant Blend

Compatible tint pastes available for blending to generate a target color were characterized in terms of their relative hiding at optical wavelengths by preparing a reference coating colored with a single tint paste at a known pigment weight concentration. The reference coating was applied to a transparent substrate at a known coating thickness, and the light transmission at optical wavelengths was determined using an integrating sphere spectrometer. A subset of available tints were selected, based on their hiding at optical wavelengths and their pigment-to-binder ratio. Tints which showed high hiding, i.e., low levels of transmission at optical wavelengths, were selected over those showing lower levels of hiding, i.e., higher levels of transmission at the same pigment weight concentration in the reference coating. Tints that showed low pigment-to-binder ratios, i.e. lower relative levels of grind vehicle for a given weight of pigment, were selected over those with higher pigment to binder ratios. The absorbance spectra for these tints were measured. A subset of these tints were identified, which, according to a mathematical algorithm, had a combined spectrum that approximated the extinction minimum and curve symmetry of the scaled conventional blend of Example 2. This colorant blend was prepared from the following components listed in Table 4 to provide a target color with adequate hiding of optical wavelengths while minimizing the amount of pigment and the amount of grind vehicle (binder) in the tint paste.

TABLE 4
High binding colorant blend

| | PARTS BY |
|---|---|
| COMPONENT | WEIGHT (grams) |
| Carbon black tint paste | 6.92 |
| Titanium dioxide tint paste | 64.00 |
| Pigment blue 60 tint paste | 27.20 |
| Pigment red 122 tint paste | 11.67 |
| Pigment blue 15:1 tint paste | 74.29 |
| Pigment green 7 tint paste¹⁴ | 16.92 |

¹⁴Tint paste comprising 13.0 grams pigment green 7 (Color Index number 74260) dispersed in a mixture comprising 30.27 grams waterborne acrylic polymer, 15.0 grams latex, 37.3 grams deionized water, 3.8 grams ethylene glycol monohexyl ether, 0.4 grams dimethylethanolamine, and 3.1 g mineral spirits such that the final pigment to binder ratio of the mixture is 0.73.

### Example 4

### Aqueous Coating Composition with High Hiding Colorant Blend

An aqueous basecoat composition containing the colorant blend of Example 3 was prepared by mixing the component listed in Table 5 under agitation. The pH of the composition was adjusted to 8.4-8.6 using an appropriate amount of a 50% aqueous solution of dimethylethanolamine. The viscosity of the aqueous basecoat composition then was reduced to 33 to 37 seconds spray viscosity (DIN #4 cup) using deionized water.

TABLE 5
Aqueous basecoat composition with colorant blend

| | PARTS BY |
|---|---|
| COMPONENT | WEIGHT (grams) |
| Premix A | 218.3 |
| Colorant blend of Ex. 3 | 204.8 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 23.3 |
| Polypropylene glycol | 5.0 |

### Example 5

### Hypothetical Aqueous Coating Composition with Conventional Colorant Blend Scaled for Hiding

An aqueous basecoat composition containing 4.85 times the amount of colorant blend used in Example 2 could be prepared from the components listed in Table 6.

TABLE 6
Aqueous basecoat composition with high level colorant blend

| | PARTS BY WEIGHT |
|---|---|
| COMPONENT | (grams) |
| Premix A | 30.2 |
| Conventional colorant blend of Ex. 1 | 626.6 |
| Deionized water | 58.9 |
| Dimethlethanolamine | 0.6 |
| Propylene glycol monobutyl ether | 9.6 |
| Ethylene glycol monohoxl ether | 9.1 |
| Cymel 327 | 3.0 |
| Polypropylene glycol | 0.7 |

The coatings produced in Example 2 (comparative) and Example 4 were analyzed for pigment loading, color match, hiding (transmission of optical wavelengths), film properties and workability. The hypothetical basecoat (Example 5) was not prepared because it was expected that when the level of binder as grind vehicle for the tints described significantly exceeds the level of functional resins and cross linker in the coating composition, unacceptable coating film properties and unacceptable application workability results. This data is summarized in Table 7.

TABLE 7
Comparison of coatings with colorant blends for light, green-blue

| | | | Hypothetical |
|---|---|---|---|
| | Example 2 | | Example 5 with |
| | with | | 485× scaling of |
| | conventional | Example 4 | conventional |
| | color blend | (invention) | colorant blend |
| Pigment to binder ratio | 0.14 | 0.47 | 0.68 |
| Grind vehicle to binder | 0.184 | 0.262 | 0.894 |
| ratio | | | |
| Pigment to grind vehicle | 0.76 | 1.79 | 0.76 |
| ratio | | | |
| Color match | Acceptable | Acceptable | Acceptable |
| Hiding/transmission | Not acceptable | Acceptable | Acceptable |
| Film properties | Acceptable | Acceptable | Not acceptable |
| Workability | Acceptable | Acceptable | Not acceptable |

The color match, film properties and application workability are all acceptable for comparative Example 2, however, the hiding or transmission characteristics of this system were not acceptable. Theoretical comparative Example 5 shows that by scaling up the amount of the conventional colorant blend (by a factor of 4.85) to achieve acceptable hiding or transmission characteristics, the pigment to binder ratio and the grind vehicle to binder ratio also increase significantly. These high levels are known to adversely impact film properties and application workability.

However, Example 4 shows that where the colorant blend is derived, pursuant to the present invention, by mathematical selection of the pigment based on desirable color properties and hiding characteristics, while minimizing pigment level and grind vehicle level, an acceptable color match can be achieved with the necessary level of hiding, without compromising film properties or application workability.

### Examples 6-9

### Dark Blue Colored Basecoat Coating Compositions

### Example 6

### Conventional Colorant Blend

A conventional colorant blend was prepared as described below from the components listed in Table 8. This colorant blend was determined by using conventional color matching techniques to match a color standard.

TABLE 8
Conventional colorant blend

| | PARTS BY |
|---|---|
| COMPONENT | WEIGHT (grams) |
| Carbon Black tint aste | 7.3 |
| Titanium dioxide tint paste | 2.3 |
| Pigment blue 60 tint paste | 83.7 |
| Pigment blue 15:1 tint paste | 54.7 |

### Example 7

### Aqueous Coating Composition with Conventional Colorant Blend

An aqueous basecoat composition was prepared by mixing the components listed in Table 9 under agitation. The pH of the composition was adjusted to 8.4-8.6 using an appropriate amount of a 50% aqueous solution of dimethylethanolamine. The viscosity of the aqueous basecoat composition was then reduced to 33 to 37 seconds spray viscosity (DIN #4 cup) using deionized water.

TABLE 9
Basecoat with conventional colorant blend

| | PARTS BY |
|---|---|
| COMPONENT | WEIGHT (grams) |
| Premix A | 228.6 |
| Conventional colorant blend of Ex. 6 | 148.0 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 22.9 |
| Polypropylene glycol | 5.0 |

An extinction spectrum was generated mathematically for the aqueous coating composition of Example 7. This generated extinction spectrum was adjusted by a scaling factor until the minimum extinction was sufficient to provide adequate hiding of optical wavelengths (300 nm to 700 nm). The scaling factor was 2.37.

### Example 8

### High Hiding Colorant Blend

A high hiding colorant blend was determined as in Example 3, except that a blend extinction spectrum was generated mathematically for the aqueous coating composition of Example 7, which was colored with the conventional colorant blend for dark blue of Example 6.

A subset of tints were identified, which according to a mathematical algorithm, had a combined spectrum that approximated the extinction minimum and curve symmetry of the scaled conventional blend of Example 7. This colorant blend was prepared from the components listed in Table 10 to provide a target color with adequate hiding of key optical wavelengths while minimizing the amount of pigment and the amount of grind vehicle (binder) in the tint paste.

TABLE 10
High hiding colorant blend

| | PARTS BY |
|---|---|
| COMPONENT | WEIGHT (grams) |
| Carbon black tint paste | 6.40 |
| Titanium dioxide tint paste | 28.00 |
| Pigment blue 60 tint paste | 68.00 |
| Pigment red 122 tint paste | 58.33 |
| Pigment green 7 tint paste | 30.77 |

### Example 9

### Aqueous Coating Composition with High Hiding Colorant Blend

An aqueous basecoat composition containing the preferred colorant blend of example 5 was prepared by mixing the components listed in Table 11 under agitation. The pH of the composition was adjusted to 8.4-8.6 using an appropriate amount of a 50% aqueous solution of dimethylethanolamine. The viscosity of the aqueous basecoat composition then was reduced to 33 to 37 seconds spray viscosity (DIN #4 cup) using deionized water.

TABLE 11
Aqueous coating composition with high hiding colorant blend

| | PARTS BY |
|---|---|
| COMPONENT | WEIGHT (grams) |
| Premix A | 217.0 |
| Colorant blend of Ex. 8 | 191.5 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 21.7 |
| Polypropylene glycol | 5.0 |

### Example 10

### Hypothetical Aqueous Coating Composition with Conventional Colorant Blend

An aqueous basecoat composition containing 2.37 times the preferred colorant of Example 7 could be prepared from the components listed in Table 12.

TABLE 12
Hypothetical aqueous coating composition with
conventional colorant blend

| | PARTS BY |
|---|---|
| COMPONENT | WEIGHT (grams) |
| Premix A | 151.2 |
| Colorant blend of Ex. 6 | 350.8 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 15.1 |
| Polypropylene glycol | 5.0 |

The coatings produced in Example 7 (comparative) and Example 9 were analyzed for pigment loading, color match, binding (transmission of optical wavelengths), film properties and workability. The hypothetical basecoat (Example 10) was not prepared because it was expected that when the level of binder as grind vehicle for the tints described significantly exceeds the level of functional resins and cross linker in the coating composition, unacceptable coating film properties and unacceptable application workability results. This data is summarized in Table 13.

TABLE 13
Comparison of coatings with colorant blends for dark blue

| | | | Hypothetical |
|---|---|---|---|
| | | | Example 10 with |
| | Example 7 | | 2.37× scaling of |
| | with conventional | Example 9 | conventional |
| | color blend | (invention) | colorant blend |
| Pigment to | 0.28 | 0.34 | 0.66 |
| binder ratio | | | |
| Grind vehicle to | 0.199 | 0.239 | 0.472 |
| binder ratio | | | |
| Pigment to grind | 1.41 | 1.42 | 1.41 |
| vehicle ratio | | | |
| Color match | Acceptable | Acceptable | Acceptable |
| Hiding/transmission | Not acceptable | Acceptable | Acceptable |
| Film properties | Acceptable | Acceptable | Not Acceptable |
| Workability | Acceptable | Acceptable | Not Acceptable |

The color match, film properties and application workability are all acceptable for comparative Example 7, which is colored with colorant blend of Example 6, however, the hiding or transmission characteristics of this system are not acceptable for the specified purpose. Theoretical Example 10 shows that by scaling up the amount of the conventional colorant blend to achieve acceptable hiding or transmission characteristics, the pigment to binder ratio and the grind vehicle to binder ratio also increases significantly. These levels are known to adversely impact film properties and application workability.

However, in Example 9, where the colorant blend is derived pursuant to the present invention by mathematical selection of the pigment combination with desirable color properties and hiding characteristics, while minimizing pigment level and grind vehicle level, an acceptable color match can be achieved with the necessary level of hiding, without compromising film properties or application workability.

### Examples 11-14

### Yellow-Red Colored Basecoat Coating Compositions

### Example 11

### Conventional Colorant Blend

A conventional colorant blend was prepared as described below from the components listed in Table 14. This colorant blend was determined by using conventional color matching techniques to match a color standard.

TABLE 14
Conventional color blend

| COMPONENT | PARTS BY WEIGHT (grams) |
|---|---|
| Carbon Black tint paste | 8.5 |
| Titanium dioxide tint paste | 30.4 |
| Pigment Red 179 tint paste¹⁵ | 150.0 |
| Pigment Red 101 tint paste¹⁶ | 38.8 |
| Pigment Red 122 tint paste | 6.7 |

¹⁵Tint paste comprising 12 grams pigment red 179 (Color Index number 71130) dispersed in a mixture comprising 24.1 grams waterborne acrylic polymer, 11.9 grams latex, 43.64 grams deionized water, 2.8 grams ethylene glycol monohexyl ether, 1.0 grams dimethylethanolamine, and 1.2 g mineral spirits such that the final pigment to binder ratio of the mixture is 0.99.
¹⁷ Tint paste comprising 13 grams pigment red 101 (Color Index number 77491) dispersed in a mixture comprising 26.5 grams waterborne acrylic polymer, 13.0 grams latex, 36.38 grams deionized water, 3.8 grams ethylene glycol monohexyl ether, 1.0 grams dimethylethanolamine, and 1.0 g mineral spirits such that the final pigment to binder ratio of the mixture is 0.99.

### Example 12

### Aqueous Coating Composition with Conventional Colorant Blend

An aqueous basecoat composition was prepared by mixing the components listed in Table 15 under agitation. The pH of the composition was adjusted to 8.4-8.6 using an appropriate amount of a 50% aqueous solution of dimethylethanolamine. The viscosity of the aqueous basecoat composition then was reduced to 33 to 37 seconds spray viscosity (DIN #4 cup) using deiionized water.

TABLE 15
Aqueous coating composition with conventional colorant blend

| | PARTS BY |
|---|---|
| COMPONENT | WEIGHT (grams) |
| Premix A | 203.0 |
| Colorant blend of Ex. 11 | 235.3 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 20.3 |
| Polypropylene glycol | 5.0 |

An extinction spectrum was generated mathematically for the aqueous coating composition of Example 12. This generated extinction spectrum was adjusted by a scaling factor until the minimum extinction was sufficient to provide adequate hiding of optical wavelengths (300 nm to 700 nm). The scaling factor was 0.71.

### Example 13

### High Hiding Colorant Blend

A high hiding colorant blend was determined as in Example 3 except that a blend extinction spectrum was generated mathematically for aqueous coating composition of Example 12 which is colored with the conventional colorant blend for low chroma yellow red of Example 11.

A subset of tints were identified which, according to a mathematical algorithm, have a combined spectrum that approximated the extinction minimum and curve symmetry of the scaled conventional blend of Example 12. This colorant blend was prepared as described below from the components listed in Table 16 to provide a color desired color with adequate hiding of key optical wavelengths while minimizing the amount of pigment and the amount of grind vehicle (binder) in the tint paste.

TABLE 16
High hiding colorant blend

| | PARTS BY |
|---|---|
| COMPONENT | WEIGHT (grams) |
| Carbon Black tint paste | 4.6 |
| Titanium dioxide tint paste | 22.0 |
| Pigment red 179 tint paste | 100.0 |
| Pigment red 101 tint paste | 17.7 |
| Pigment red 122 tint paste | 3.3 |

### Example 14

### Aqueous Coating Composition with High Hiding Colorant Blend

An aqueous basecoat composition containing the high hiding colorant blend of Example 13 was prepared by mixing the components listed in Table 17 under agitation. The pH of the composition was adjusted to 8.4-8.6 using an appropriate amount of a 50% aqueous solution of dimethylethanolamine. The viscosity of the aqueous basecoat composition then was reduced to 33 to 37 seconds spray viscosity (DIN #4 cup) using deionized water.

TABLE 17
Aqueous coating composition with high hiding colorant blend

| | PARTS BY |
|---|---|
| COMPONENT | WEIGHT (grams) |
| Premix A | 235.0 |
| Colorant blend of Ex. 11 | 143.5 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 23.5 |
| Polypropylene glycol | 5.0 |

### Example 15

### Hypothetical Aqueous Coating Composition with Conventional Colorant Blend Scaled for Hiding

An aqueous basecoat composition containing 0.71 times the preferred colorant blend of Example 12 could be prepared from the components listed in Table 18.

TABLE 18
Hypothetical aqueous coating composition with conventional
colorant blend scaled for hiding

| | PARTS BY |
|---|---|
| COMPONENT | WEIGHT (grams) |
| Premix A | 226.8 |
| Colorant blend of Ex. 11 | 167.1 |
| Deionized water | 58.9 |
| Dimethylethanolamine | 0.6 |
| Propylene glycol monobutyl ether | 9.6 |
| Ethylene glycol monohexyl ether | 9.1 |
| Cymel 327 | 22.7 |
| Polypropylene glycol | 5.0 |

The coatings produced in Example 12 (comparative) and Example 14 were analyzed for pigment loading, color match, binding (transmission of optical wavelengths), film properties and workability. The hypothetical basecoat of Example 15 was not prepared. This data is summarized in Table 19.

TABLE 19
Comparison of coatings with colorant blends for
low chroma, yellow-red

| | Example 12 | | Hypothetical Example |
|---|---|---|---|
| | with | | 15 with 0.71× scaling |
| | conventional | Example 14 | of conventional |
| | colorant blend | (invention) | colorant blend |
| Pigment to | 0.40 | 0.26 | 0.28 |
| binder ratio | | | |
| Grind vehicle to | 0.288 | 0.180 | 0.204 |
| binder ratio | | | |
| Pigment to grind | 1.39 | 1.44 | 1.39 |
| vehicle ratio | | | |
| Color match | Acceptable | Acceptable | Acceptable |
| Hiding/ | Acceptable | Acceptable | Acceptable |
| transmission | | | |
| Film properties | Acceptable | Acceptable | Acceptable |
| Workability | Not acceptable | Acceptable | Acceptable |

The color match, and film properties are acceptable for Example 12 which is colored with colorant blend of Example 11. The hiding or transmission characteristics of this system are also acceptable for the specified purpose. However, the high level of grind vehicle relative to functional binder gives unacceptable application workability. Theoretical Example 15 shows that by decreasing the level of the conventional colorant blend to achieve a level that still provides acceptable hiding or transmission characteristics, the pigment to binder ratio and the grind vehicle to binder ratio also decreases significantly. However, in Example 14, where the colorant blend is derived by mathematical selection of the pigment combination with desirable color properties, and hiding characteristics, while minimizing pigment level and grind vehicle level, an acceptable color match can be achieved with the necessary level of hiding, while further improving the pigment to binder ratio, grind vehicle to binder ratio and pigment to grind vehicle ratio to favor film properties or application workability.

Whereas particular embodiments of this invention have been described above for the purpose of illustration, it will be evident to those skilled in the art that numerous variations of the details of the present invention may be made without departing from the invention as defined in the appended claims.

What is claimed is:

1. A method of selecting tints for use in preparing a colored coating composition comprising:
(a) providing a plurality of tints, each tint comprising a colorant dispersed in a resinous carrier binder;
(b) preparing a plurality of coating compositions, each coating composition comprising a resinous coating binder that is the same or different from the resinous carrier binder and at least one said tint, the total binder content being the amount of carrier binder and coating binder;
(c) determining the absorbance of radiation in a wavelength band of each coating composition; and
(d) identifying coating compositions of step (b) having a predetermined maximum weight ratio of colorant to total binder and a predetermined maximum amount of resinous carrier binder and having a predetermined minimum absorbance in the wavelength band.

2. The method of claim 1, wherein the wavelength band is 300-470 nm.

3. The method of claim 2, wherein the resinous carrier binder comprises less than 20 wt. % of the total binder.

4. The method of claim 2, further comprising selecting the tints from the coating compositions identified in step (d) for use in preparing a colored coating composition.

5. The method of claim 4, further comprising determining a target absorbance spectrum for a colored coating composition and determining a set of the identified tints having absorbance spectra that, in combination, match the target absorbance spectrum.

6. The method of claim 5, wherein the target absorbance spectrum is obtained by measuring the absorbance of a pre-existing color sample.

7. The method of claim 5, wherein curves of the absorbance spectra of the identified tints are selected to match the curve of the target absorbance spectrum.

8. The method of claim 3, wherein the amount of tint included in the coating composition is adjusted to achieve the minimum absorbance in the wavelength band.

9. A primeness coating system comprising a resinous electrocoated layer and a basecoat layer applied directly thereto, said basecoat layer comprising a colored coating composition comprising a basecoat binder and a plurality of tints comprising a colorant and a carrier binder, wherein said tints in combination exhibit a target absorbance spectrum and said coating composition exhibits a minimum absorbance in a wavelength band, wherein the amount of carrier binder in the composition is less than 20 wt. % of the total amount of the basecoat binder and the carrier binder.

10. The coating system of claim 9, wherein said wavelength band is 300-470 nm.

11. The coating system of claim 10, wherein each said tint exhibits said minimum absorbance.

12. An article comprising a substrate coated with the coating system of claim 9.

13. The article of claim 12 further comprising a clear coat layer covering said coating system.

14. The article of claim 12 wherein said substrate is metallic.

15. A coated substrate comprising:
a metal substrate covered by an electrodeposited coating layer;
a coating system applied to the electrodeposited layer without a primer layer therebetween, said coating system comprising a hiding layer and a color layer;
wherein said hiding layer comprises a binder and a plurality of tints comprising a colorant and a carrier binder, wherein said tints in combination exhibit a target absorbance spectrum, each of said tints exhibiting at least a predetermined minimum absorbance at 300-470 nm.

16. The coated substrate of claim 15, wherein said color layer comprises a pigment or special effect composition or both.

17. The coated substrate of claim 15, further comprising a clearcoat layer over at least a portion of coating composition.

18. A colored coating composition comprising a coating binder and tints, said tints selected according to the method of claim 1.

19. An article comprising a substrate coated at least in part with the coating composition of claim 18.

20. The article of claim 19, wherein said substrate is metallic.
